(19) United States
(12) Patent Application Publication
(10) Pub. No.: US 2026/0099778 A1
(43) Pub. Date: Apr. 9, 2026

(54) COORDINATOR FOR DIVERSE AI ASSISTANTS

(71) Applicant: Microsoft Technology Licensing, LLC, Redmond, WA (US)

(72) Inventor: Elizabeth Nancy CARTER, Bellevue, WA (US)

(21) Appl. No.: 18/906,162

(22) Filed: Oct. 3, 2024

(51) Int. Cl. G06Q 10/0631

(52) U.S. Cl. CPC G06Q 10/0631

(57) ABSTRACT

A coordinator for diverse artificial intelligence (AI) assistants (e.g., Copilot, Gemini) is disclosed that improves the efficiency of using multiple custom AI assistants for complex tasks. The example AI assistant coordinator receives a user input comprising a task and selects one or more AI assistants, from among a predefined set of AI assistants, to perform the task. Some scenarios partition the task into portions, each of which is performed by a different AI assistant, and then the multiple results are aggregated by the coordinator. Some scenarios use a result from one AI assistant within the tasking for another AI assistant. The AI coordinator is capable of emulating a human user when interacting with the AI assistants (i.e., when using an API is not feasible), and also performing an action such as sending an email or generating a document, based on the input task and results from the AI assistants.

### BACKGROUND

Artificial intelligence (AI) assistants, such as Copilot, Gemini, and other generative AI tools, are often customized for various differing tasks. Examples include email generation, finance, security, enterprise productivity, sales, software generation/completion, and other applications. This results in a suite (or set) of diverse AI assistants, each with a different specialized capability.

When a user of AI assistants is presented with a task that spans multiple custom AI assistants, the user needs to partition the task into multiple portions that are each suitable to a specific AI assistant, assign each portion to the suitable AI assistant, and then manually compile the results. Although the use of the AI assistants may improve efficiency and reduce the time required to complete the task when compared with the use performing the entire task manually, the use is still spending time on partitioning the task and compiling the results.

### SUMMARY

The disclosed examples are described in detail below with reference to the accompanying drawing figures listed below. The following summary is provided to illustrate some examples disclosed herein.

Example coordinators for diverse artificial intelligence (AI) assistants improve the efficiency of using multiple custom AI assistants for complex tasks that span the domain of multiple ones of the AI assistants. Examples receive, by an AI assistant coordinator, a user input comprising a task; select a first AI assistant, in a set of AI assistants, to perform at least a first portion of the task; select a second AI assistant in the set of AI assistants to perform at least a second portion of the task; instruct the first AI assistant to perform the first portion of the task; receive a first result from the first AI assistant; instruct the second AI assistant to perform the second portion of the task; receive a second result from the second AI assistant; compile the first result and the second result into an aggregated result; and perform an action using the aggregated result, based on at least the task.

Additional examples receive, by an AI assistant coordinator, a user input comprising a task; select a first AI assistant, in a set of AI assistants, to perform at least a first portion of the task; select a first data source, in a set of data sources, to perform at least the first portion of the task; instruct the first AI assistant to perform the first portion of the task using the first data source; receive a first result from the first AI assistant; and perform an action using the first result, based on at least the task. Further examples receive, by an AI assistant coordinator, a user input comprising a task; select a first AI assistant, in a set of AI assistants, to perform at least a first portion of the task; instruct the first AI assistant, with a user emulator, to perform the first portion of the task; receive a first result from the first AI assistant; and perform an action using the first result, based on at least the task.

### BRIEF DESCRIPTION OF THE DRAWINGS

The disclosed examples are described in detail below with reference to the accompanying drawing figures listed below:

FIG. 1 illustrates an example architecture that advantageously provides an artificial intelligence (AI) assistant coordinator for diverse AI assistants and data sources;

FIG. 2 illustrates an exemplary user input to the AI assistant coordinator of FIG. 1;

FIG. 3A illustrates an exemplary set of AI assistants, as may be used in examples of the architecture of FIG. 1;

FIG. 3B illustrates an exemplary set of data sources, as may be used in examples of the architecture of FIG. 1;

FIG. 4 illustrates an exemplary credential vault that may be used to access the set of AI assistants of FIG. 3A and the set of data sources of FIG. 3B;

FIG. 5 illustrates an exemplary messaging scenario, as may occur when using examples of the architecture of FIG. 1;

FIG. 6 illustrates performance of an exemplary action, as may occur when using examples of the architecture of FIG. 1;

FIGS. 7, 8A, 8B, and 8C show flowcharts illustrating exemplary operations that may be performed when using example architectures, such as the architecture of FIG. 1; and

FIG. 9 shows a block diagram of an example computing device suitable for implementing some of the various examples disclosed herein.

Corresponding reference characters indicate corresponding parts throughout the drawings.

### DETAILED DESCRIPTION

A coordinator for diverse artificial intelligence (AI) assistants (e.g., Copilot, Gemini) is disclosed that improves the efficiency of using multiple custom AI assistants for complex tasks that span the domain of multiple ones of the AI assistants. The example AI assistant coordinator receives a user input comprising a task and selects one or more AI assistants, from among a predefined set of AI assistants, to perform the task. Some scenarios partition the task into portions, each of which is performed by a different AI assistant, and then the multiple results are aggregated by the coordinator. Some scenarios use a result from one AI assistant within the tasking for another AI assistant. The AI assistant coordinator is capable of emulating a human user when interacting with the AI assistants (i.e., when using an API is not feasible), and also performing an action such as sending an email or generating a document, based on the input task and results from the AI assistants.

Aspects of the disclosure solve multiple problems that are necessarily rooted in computer technology and render computing platforms more efficient and easier to use, by providing the practical result of coordinating the operation of multiple, diverse AI assistants on complex tasks, when the AI assistants are each customized with various differing specialized capability. This reduces the technical expertise and time required to leverage AI assistants, and is accomplished, at least in part by, an AI assistant coordinator selecting a first AI assistant, in a set of AI assistants, to perform at least a first portion of a task, selecting a second AI assistant in the set of AI assistants to perform at least a second portion of the task, and compiling a first result (from the first AI assistant) and a second result (from the second AI assistant) into an aggregated result.

Examples provide a single interface for users to retrieve all information and perform all tasks that can be done by a suite of customized AI assistants. All of the customized AI assistants may be employed seamlessly using the single interface (e.g., a chat prompt). Security is preserved by the AI assistant coordinator leveraging vaulted access credentials for AI assistants and data sources that require such credentials.

This saves time and increases productivity, while avoiding the redundancy of creating new custom AI assistants with the functionality of multiple, independent existing AI assistants (that have already been trained). Some examples are able to identify to the user which AI assistant was used in responding to a particular question or prompt. Areas in which the novel teachings herein may be used include: customer support and ticket management, sales and customer relations management (CRM) interaction, project management and collaboration, healthcare and patient records management, financial services and investment portfolio management, legal case management, and others.

The various examples will be described in detail with reference to the accompanying drawings. Wherever preferable, the same reference numbers will be used throughout the drawings to refer to the same or like parts. References made throughout this disclosure relating to specific examples and implementations are provided solely for illustrative purposes but, unless indicated to the contrary, are not meant to limit all examples.

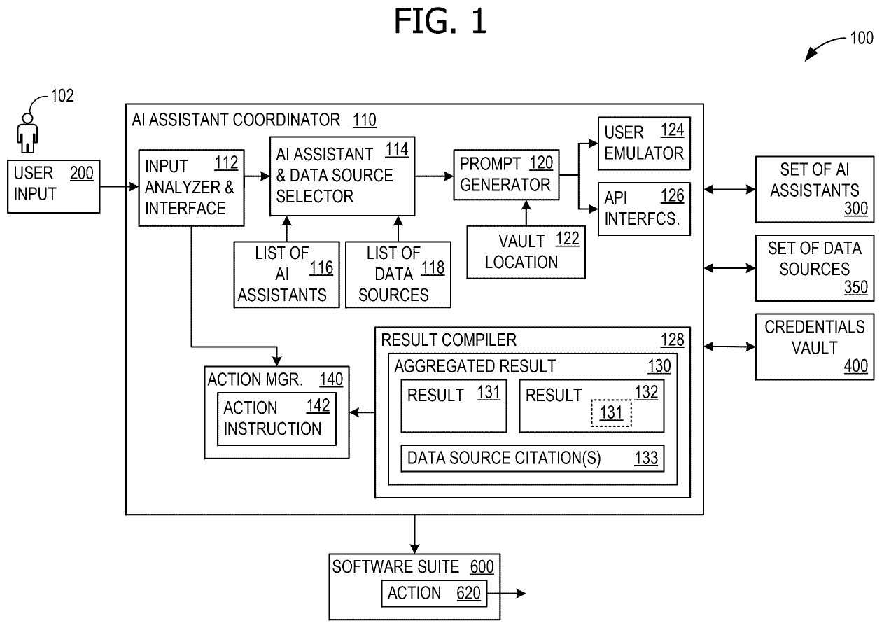

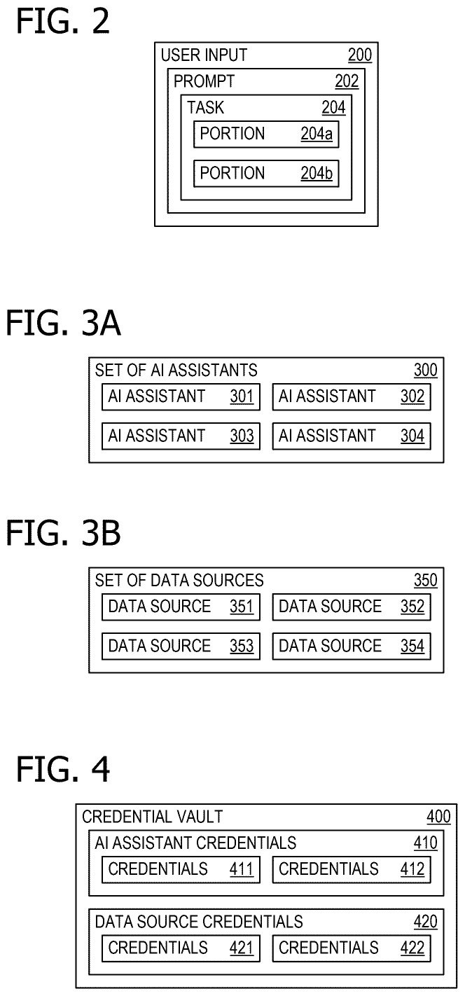

FIG. 1 illustrates an example architecture 100 that employs an AI assistant coordinator 110 for a diverse set of AI assistants 300 that uses a set of data sources 350. A user 102 generates a user input 200 (which is shown in further detail in FIG. 2) that includes a task for one or more AI assistants of set of AI assistants 300. In some examples, user 102 engages in a chat with AI assistant coordinator 110, and user input 200 is one or more statements by user 102 within the chat session. User input 200 is provided to AI assistant coordinator 110, which parses and analyzes user input 200 with an input analyzer 112. Input analyzer 112 acts as an interface for user 102, and may itself include AI and provide chat functionality.

Input analyzer 112 identifies a task 204 (see FIG. 2) within user input 200, such as by using a language model, and an AI assistant and data source selector 114 selects one or more specific AI assistants and data sources to accomplish task 204. AI assistant and data source selector 114 is able to reference a list 116 of AI assistants within set of AI assistants 300 and a list 118 of data sources within set of data sources 350, and may itself contain an AI model. In some examples, user 102 may provide a selection of a particular AI assistant for a particular portion of task 204 within user input 200, if desired.

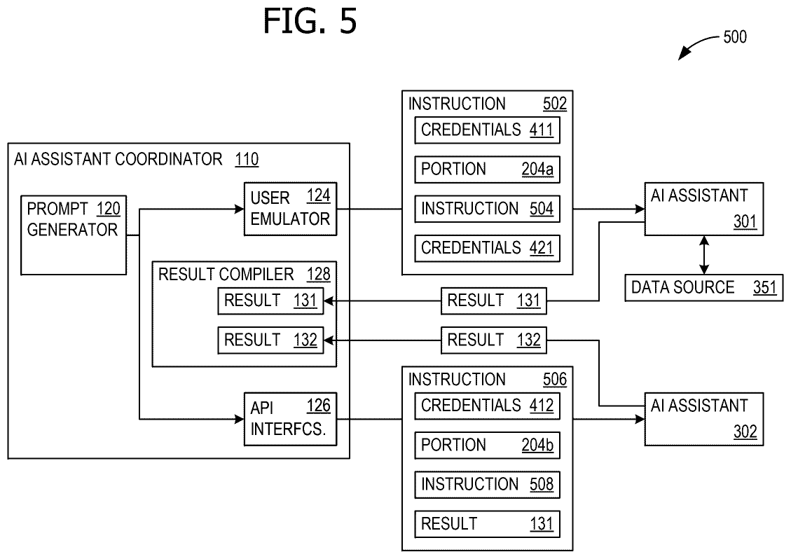

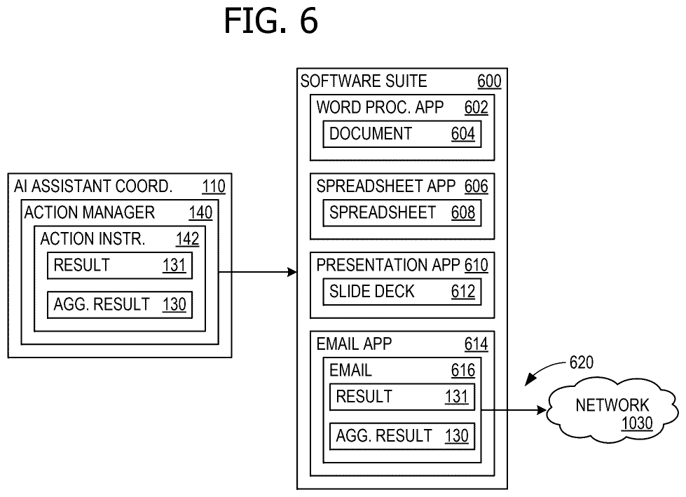

Set of AI assistants 300 is a suite of diverse AI assistants, each with a different specialized capability. Examples of AI assistants that may be within set of AI assistants 300 include AI assistants that have been customized for email generation, performing finance functions, performing security functions, assisting with enterprise productivity software applications, sales assistance, software generation and/or completion, searching assistance, and other applications. Set of AI assistants 300 is shown in further detail in FIG. 3A and set of data sources 350 is shown in further detail in FIG. 3B.

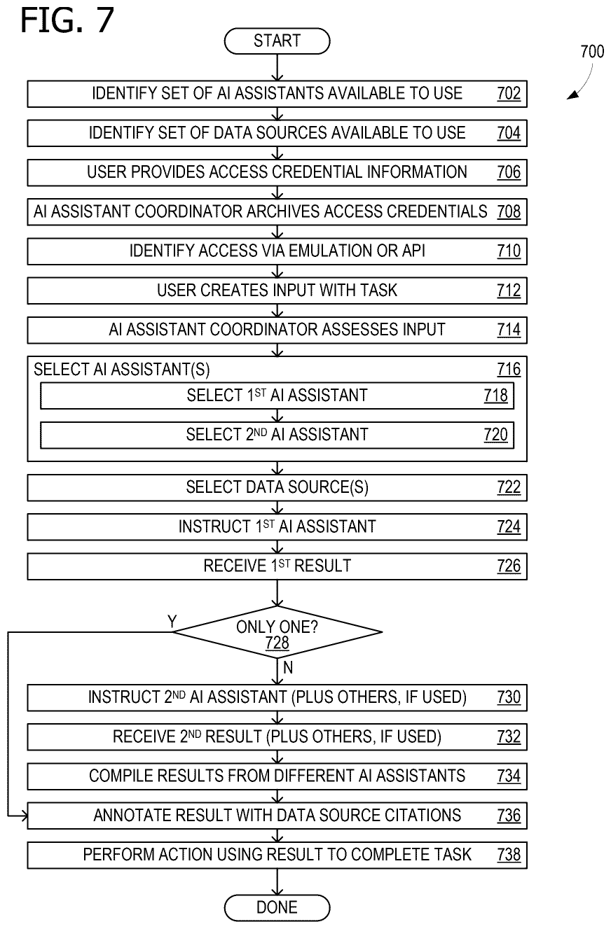

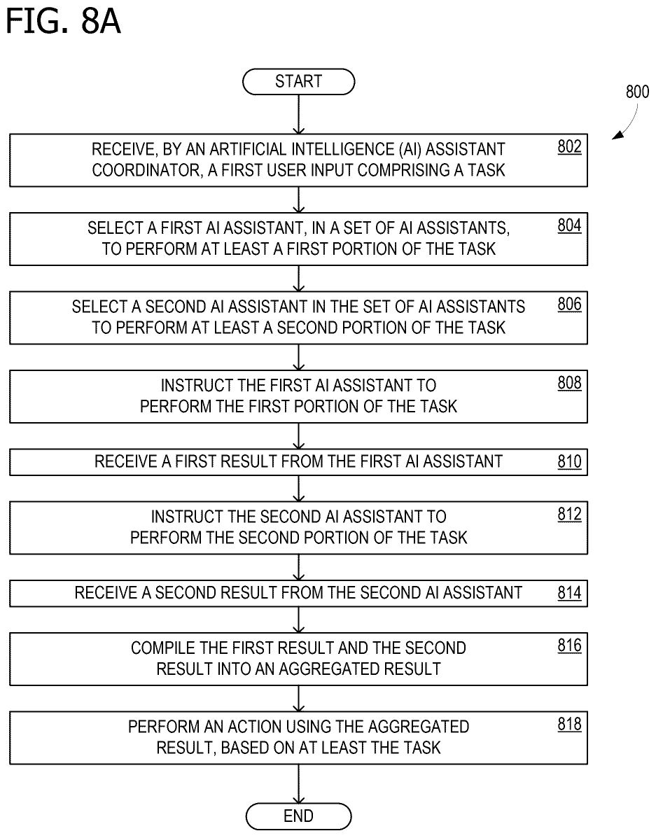

A prompt generator 120 generates instructions for each of the selected AI assistants, as shown in FIG. 5, and described below. In some scenarios various AI assistants and data sources require login credentials, which are stored in a credentials vault 400, identified within AI assistant coordinator 110 using a location 122. Credential vault 400 is shown in further detail in FIG. 4. Prompt generator 120 includes the needed credentials in the instructions (prompts) sent to the selected AI assistant(s).

AI assistant coordinator 110 interacts with the various AI assistants of set of AI assistants 300 using either a user emulator 124 or API interfaces 126. When an AI assistant is accessible via an API, the proper API is selected and used from API interfaces 126. However, when an AI assistant is configured for human interaction, AI assistant coordinator 110 uses user emulator 124 to mimic a human user when interacting with that AI assistant. An example of this is shown in FIG. 5.

Results received from the selected AI assistants are received by AI assistant coordinator 110 into a result compiler 128. As illustrated, a first result 131 is received from a first selected AI assistant, and a second result 132 is received from a second selected AI assistant. This is described in further detail in relation to FIG. 5. In some scenarios, only a single AI assistant is selected and used, and returns result 131 as the final result. In some scenarios, two (or more) AI assistants are selected and used independently, and return at least result 131 and result 132. In these scenarios, result compiler 128 compiles result 131 and result 132 into an aggregated result 130 as the final result.

In yet other scenarios, one of the selected AI assistants requires the result from another of the selected AI assistants, in order to perform its portion of the task. For example, result 131 is returned from a first one of the selected AI assistants and furnished as part of the input to a second one of the selected AI assistants. The second selected AI assistant then returns result 132 which includes (is at least partially based on result 131). This scenario is illustrated by showing result 131 in dotted lines inside result 132.

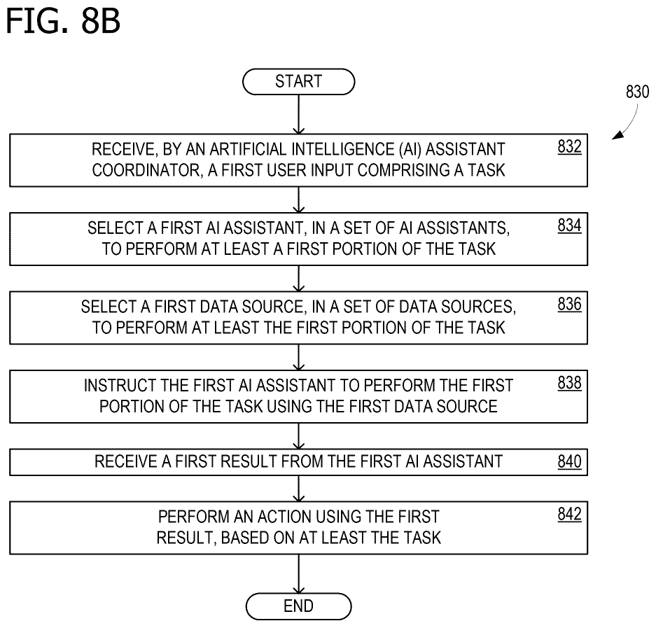

In some examples, result compiler 128 adds citations to the data sources that had been used or identifying the AI assistant used, when outputting the final result (e.g., result 131 or aggregated result 130). As illustrated, a citation 133 has been added to aggregated result 130 that identifies one or more of AI assistant 301, AI assistant 302, and data source 351with a particular portion of aggregated result 130. An action manager 140 is able to perform an action 620 using an action instruction 142. Action 620 is part of the task (task 204) identified in user input 200 and uses the final result from result compiler 128 (e.g., result 131 or aggregated result 130). In some examples, action instruction 142 may be sent to an enterprise productivity software suite 600 (e.g., via an API). Enterprise productivity software suite 600 includes multiple software packages for document and email generation, and is shown in further detail in FIG. 6.

FIG. 2 illustrates further detail for user input 200. The exemplary illustration of user input 200 is in the form of a prompt 202 for AI assistant coordinator 110 to process, and includes task 204. Although, as input by user 102, task 204 may be singular, it is shown in its constituent components, a portion 204a and a portion 204b. However, portion 204a and portion 204b may be separated out by input analyzer 112, based on the set of AI assistants identified (along with their capabilities) in list 116 of AI assistants.

FIG. 3A illustrates further detail for set of AI assistants 300. As illustrated, set of AI assistants 300 has four different AI assistants: an AI assistant 301, an AI assistant 302, an AI assistant 303, and an AI assistant 304. Some examples use a different count of AI assistants. FIG. 3B illustrates further detail for set of data sources 350. As illustrated, set of data sources 350 four different data sources: a data source 351, a data source 352, a data source 353, and a data source 354. Data sources may include enterprise productivity software suite 600 (e.g., emails, contact address books, documents such as spreadsheets), calendar applications, databases, online data sources both public and proprietary, and others. Some examples use a different count of data sources.

FIG. 4 illustrates further detail for credential vault 400. Credential vault 400 represents a general secure vault (e.g., a password manager), and in some examples, the functionality described herein for credential vault 400 may be distributed. In such scenarios, location 122 identifies all of the distributed locations. Credential vault 400 includes access credentials 410 for each AI assistant that requires access credentials. As an illustrated example, access credentials 410 has access credentials 411 for AI assistant 301 and access credentials 412 for AI assistant 302. Credential vault 400 also includes access credentials 412 for each data source that requires access credentials. As an illustrated example, access credentials 420 has access credentials 421 for data source 351 and access credentials 422 for data source 352.

FIG. 5 illustrates an exemplary messaging scenario 500, as may occur when AI assistant coordinator 110 interfaces with AI assistant 301 and AI assistant 302. In the illustrated example, AI assistant coordinator 110 employs user emulator 124 to interface with (including instructing) AI assistant 301 and employs API interfaces 126 to interface with (including instructing) AI assistant 302. In this scenario, AI assistant 301 does not support interaction via an API, whereas AI assistant 302 does support interaction via an API.

Prompt generator 120 generates an instruction 502 (e.g., a prompt) for AI assistant 301 that includes access credentials 411 (for AI assistant 301), portion 204a of task 204, an instruction 504 for AI assistant 301 to use data source 351, and access credentials 421 for AI assistant 301to use when accessing data source 351. AI assistant 301 performs portion 204a of task 204, using data source 351, and returns result 131.

In this illustrated scenario, result 131 is forwarded to prompt generator 120 to use when generating an instruction 506 (e.g., a prompt) for AI assistant 302, because performing portion 204a of task 204 requires using result 131. Instruction 506 includes access credentials 412 (for AI assistant 302), portion 204b of task 204, and an instruction 508 for AI assistant 302 to use result 131. AI assistant 301 performs portion 204b of task 204, using result 131, and returns result 132.

FIG. 6 illustrates performance of exemplary action 620 by AI assistant coordinator 110. Action manager 140 receives instruction from input analyzer 112 regarding what action to perform, and generates action instruction 142 based on at least task 204 and aggregated result 130 (or result 131). AI assistant coordinator 110 sends action instruction 142 to enterprise productivity software suite 600 in the illustrated example, but may perform other actions in addition or instead. In some examples, action instruction 142 may be sent via API.

As shown, enterprise productivity software suite 600 includes a word processing software application 602, a spreadsheet software application 606, a presentation software application 610, and an email software application 614, although other productivity software titles may be used in some examples. Word processing software application 602 is able to generate and save a word processing document 604; spreadsheet software application 606 is able to generate and save a spreadsheet 608; presentation software application 610 is able to generate and save a presentation slide deck 612; and email software application 614 is able to generate and transmit an email 616 to selected recipients. Email 616 includes aggregated result 130 (or result 131). The generation and transmission of email 616 is shown as action 620. Some examples may create a calendar event using aggregated result 130 (or result 131).

In some examples, action 620 includes multiple steps. For example, word processing software application 602 generates and saves word processing document 604, and spreadsheet software application 606 generates and saves spreadsheet 608, and then email software application 614 generates email 616 with both word processing document 604 and spreadsheet 608 attached and transmits email 616 to the selected recipients.

As an example, user input 200 may be: “Generate a spreadsheet with the new sales figures from the latest quarterly report, and send the spreadsheet to my supervisor in an email with my standard greeting and signature block.” Such a user input 200 has multiple portions, such as retrieving and extracting information from the latest quarterly report, generating and saving a new spreadsheet with the extracted information, accessing the organizational chart to identify the supervisor, generating an email with the specified information and the spreadsheet attached, and then causing the email to be transmitted. The use of AI assistant coordinator 110 thus saves significant time, because user 102 only needs to type out the example user input 200 identified above and then, at a later time, verify that the email and spreadsheet are accurate.

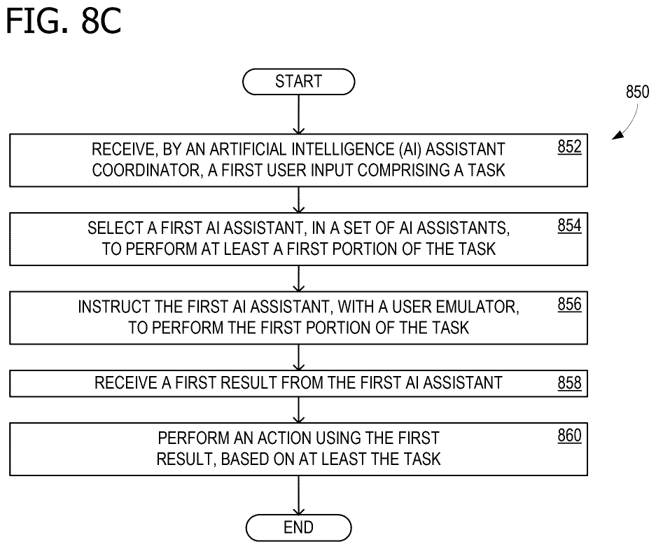

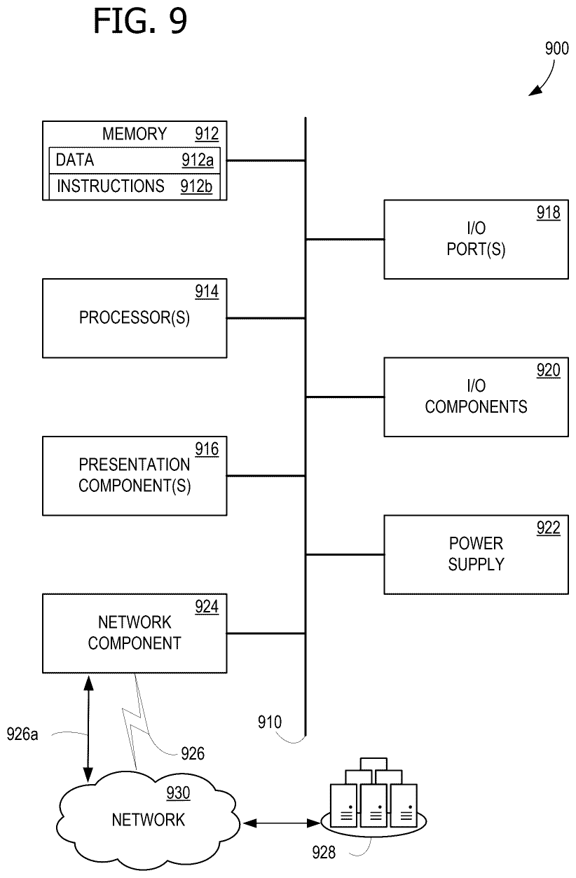

FIG. 7 shows a flowchart 700 illustrating exemplary operations that may be performed by architecture 100. In some examples, operations described for flowchart 700 are performed by computing device 900 of FIG. 9. Flowchart 700 commences with AI assistant coordinator 110 identifying set of AI assistants 300 in operation 702 and identifying set of data sources 350 in operation 704. In some examples, at least one of AI assistant 301 and AI assistant 302 comprises generative AI (and/or a Copilot or Gemini application);

In operation 706, user 102 provides access credentials for each AI assistant in set of AI assistants 300 that requires access credentials and for each data source in set of data sources 350 that requires access credentials. These are stored in credentials vault 400, and may include access credentials 411 for AI assistant 301, access credentials 412 for AI assistant 302, access credentials 421 for data source 351, and access credentials 422 for data source 352.

In operation 708, AI assistant coordinator 110 identifies location 122 of access credentials for AI assistants and data sources (e.g., the location of credentials vault 400 or distributed locations). In operation 710, AI assistant coordinator 110 identifies whether instructing each AI assistant is performed using an API, with API interfaces 126, or using user emulation, with user emulator 124.

User 102 creates user input 200, and AI assistant coordinator 110 receives user input 200, in operation 712. User input 200 comprises a prompt or a question comprising task 204. AI assistant coordinator 110 assess user input 200 in operation 714 and selects the best AI assistant for task 204 or selects the best AI assistants for each portion of task 204 in operation 716. In some examples, operation 716 is performed in two stages: operation 718 selects AI assistant 301 to perform at least portion 204a of task 204 and operation 720 selects AI assistant 302 to perform at least portion 204b of task 204. Operation 722 selects one or more data sources (e.g., data source 351) to use when performing at least a portion of task 204 (e.g., portion 204a and/or portion 204b).

In operation 724, AI assistant coordinator 110 instructs AI assistant 301 to perform portion 204a of task 204. This may include instructing AI assistant 301 to perform portion 204a of task 204 using data source 351, and may include instructing AI assistant 301 with user emulator 124. In some examples, this includes accessing AI assistant 301 with access credentials 411. Result 131 is received from AI assistant 301 in operation 726. Decision operation 728 determines whether only a single AI assistant is used, or multiple AI assistants are to be used. If only a single AI assistant is used, flowchart 700 advances to operation 736. However, if multiple AI assistants are to be used, flowchart 700 moves to operation 730. In operation 730, AI assistant coordinator 110 instructs AI assistant 302 to perform portion 204b of task 204 (along with instructing other AI assistants, if necessary). This may include instructing AI assistant 302 to perform portion 204b of task 204 using result 131 and/or data source 351, and may include instructing AI assistant 302 with user emulator 124. In some examples, this includes accessing AI assistant 302 with access credentials 412. Result 132 is received from AI assistant 302 in operation 732 (along with other results from other AI assistants, if used).

In some examples, performing portion 204b of task 204 is independent of performing portion 204a of task 204, whereas in some examples, performing portion 204b of task 204 requires use of the result of performing portion 204a of task 204 (i.e., result 131).

Operation 734 compiles result 131 and result 132 into aggregated result 130. When performing portion 204b of task 204 requires using result 131, aggregated result 130 includes result 131 within result 132. When performing portion 204b of task 204 is independent of performing portion 204a of task 204, aggregated result 130 includes result 131 alongside result 132. Operation 736 annotates aggregated result 130 (or result 131) to include citation 133 to data source 351 and/or AI assistant 301 (or AI assistant 302).

Action 620 is performed in operation 738 using aggregated result 130 (or result 131), based on at least task 204. In some examples, action 620 comprises an action such as transmitting email 616 containing aggregated result 130, appending aggregated result 130 into an enterprise suite document (e.g., word processing document 604, spreadsheet 608, or presentation slide deck 612) and storing the enterprise suite document using information within aggregated result 130.

FIG. 8A shows a flowchart 800 illustrating exemplary operations that may be performed by architecture 100. In some examples, operations described for flowchart 800 are performed by computing device 900 of FIG. 9. Flowchart 800 commences with operation 802, which includes receiving, by an AI assistant coordinator, a user input comprising a task. Operation 804 includes selecting a first AI assistant, in a set of AI assistants, to perform at least a first portion of the task.

Operation 806 includes selecting a second AI assistant in the set of AI assistants to perform at least a second portion of the task. Operation 808 includes instructing the first AI assistant to perform the first portion of the task. Operation 810 includes receiving a first result from the first AI assistant. Operation 812 includes instructing the second AI assistant to perform the second portion of the task. Operation 814 includes receiving a second result from the second AI assistant. Operation 816 includes compiling the first result and the second result into an aggregated result. Operation 818 includes performing an action using the aggregated result, based on at least the task.

FIG. 8B shows a flowchart 830 illustrating exemplary operations that may be performed by architecture 100. In some examples, operations described for flowchart 830 are performed by computing device 900 of FIG. 9. Flowchart 830 commences with operation 832, which includes receiving, by an artificial intelligence (AI) assistant coordinator, a user input comprising a task. Operation 834 includes selecting a first AI assistant, in a set of AI assistants, to perform at least a first portion of the task.

Operation 836 includes selecting a first data source, in a set of data sources, to perform at least the first portion of the task. Operation 838 includes instructing the first AI assistant to perform the first portion of the task using the first data source. Operation 840 includes receiving a first result from the first AI assistant. Operation 842 includes performing an action using the first result, based on at least the task.

FIG. 8C shows a flowchart 850 illustrating exemplary operations that may be performed by architecture 100. In some examples, operations described for flowchart 850 are performed by computing device 900 of FIG. 9. Flowchart 850 commences with operation 852, which includes receiving, by an artificial intelligence (AI) assistant coordinator, a user input comprising a task. Operation 854 includes selecting a first AI assistant, in a set of AI assistants, to perform at least a first portion of the task. Operation 856 includes instructing the first AI assistant, with a user emulator, to perform the first portion of the task. Operation 858 includes receiving a first result from the first AI assistant. Operation 860 includes performing an action using the first result, based on at least the task.

### Additional Examples

An example system comprises: a processor; and a computer-readable medium storing instructions that are operative upon execution by the processor to: receive, by an AI assistant coordinator, a user input comprising a task; select a first AI assistant, in a set of AI assistants, to perform at least a first portion of the task; select a second AI assistant in the set of AI assistants to perform at least a second portion of the task; instruct the first AI assistant to perform the first portion of the task; receive a first result from the first AI assistant; instruct the second AI assistant to perform the second portion of the task; receive a second result from the second AI assistant; compile the first result and the second result into an aggregated result; and perform an action using the aggregated result, based on at least the task.

Another example system comprises: a processor; and a computer-readable medium storing instructions that are operative upon execution by the processor to: receive, by an AI assistant coordinator, a user input comprising a task; select a first AI assistant, in a set of AI assistants, to perform at least a first portion of the task; select a first data source, in a set of data sources, to perform at least the first portion of the task; instruct the first AI assistant to perform the first portion of the task using the first data source; receive a first result from the first AI assistant; and perform an action using the first result, based on at least the task.

Another example system comprises: a processor; and a computer-readable medium storing instructions that are operative upon execution by the processor to: receive, by an AI assistant coordinator, a user input comprising a task; select a first AI assistant, in a set of AI assistants, to perform at least a first portion of the task; instruct the first AI assistant, with a user emulator, to perform the first portion of the task; receive a first result from the first AI assistant; and perform an action using the first result, based on at least the task.

An example computer-implemented method comprises: receiving, by an AI assistant coordinator, a user input comprising a task; selecting a first AI assistant, in a set of AI assistants, to perform at least a first portion of the task; selecting a second AI assistant in the set of AI assistants to perform at least a second portion of the task; instructing the first AI assistant to perform the first portion of the task; receiving a first result from the first AI assistant; instructing the second AI assistant to perform the second portion of the task; receiving a second result from the second AI assistant; compiling the first result and the second result into an aggregated result; and performing an action using the aggregated result, based on at least the task.

An example computer-implemented method comprises: receiving, by an artificial intelligence (AI) assistant coordinator, a user input comprising a task; selecting a first AI assistant, in a set of AI assistants, to perform at least a first portion of the task; selecting a first data source, in a set of data sources, to perform at least the first portion of the task; instructing the first AI assistant to perform the first portion of the task using the first data source; receiving a first result from the first AI assistant; and performing an action using the first result, based on at least the task.

An example computer-implemented method comprises: receiving, by an artificial intelligence (AI) assistant coordinator, a user input comprising a task; selecting a first AI assistant, in a set of AI assistants, to perform at least a first portion of the task; instructing the first AI assistant, with a user emulator, to perform the first portion of the task; receiving a first result from the first AI assistant; and performing an action using the first result, based on at least the task.

One or more example computer storage devices have computer-executable instructions stored thereon, which, on execution by a computer, cause the computer to perform operations comprising: receiving, by an AI assistant coordinator, a user input comprising a task; selecting a first AI assistant, in a set of AI assistants, to perform at least a first portion of the task; selecting a second AI assistant in the set of AI assistants to perform at least a second portion of the task; instructing the first AI assistant to perform the first portion of the task; receiving a first result from the first AI assistant; instructing the second AI assistant to perform the second portion of the task; receiving a second result from the second AI assistant; compiling the first result and the second result into an aggregated result; and performing an action using the aggregated result, based on at least the task.

One or more additional example computer storage devices have computer-executable instructions stored thereon, which, on execution by a computer, cause the computer to perform operations comprising: receiving, by an artificial intelligence (AI) assistant coordinator, a user input comprising a task; selecting a first AI assistant, in a set of AI assistants, to perform at least a first portion of the task; selecting a first data source, in a set of data sources, to perform at least the first portion of the task; instructing the first AI assistant to perform the first portion of the task using the first data source; receiving a first result from the first AI assistant; and performing an action using the first result, based on at least the task.

One or more additional example computer storage devices have computer-executable instructions stored thereon, which, on execution by a computer, cause the computer to perform operations comprising: receiving, by an artificial intelligence (AI) assistant coordinator, a user input comprising a task; selecting a first AI assistant, in a set of AI assistants, to perform at least a first portion of the task; instructing the first AI assistant, with a user emulator, to perform the first portion of the task; receiving a first result from the first AI assistant; and performing an action using the first result, based on at least the task.

Alternatively, or in addition to the other examples described herein, examples include any combination of the following:
the action comprises an action selected from the list consisting of: transmitting an email containing the aggregated result, appending the aggregated result into an enterprise suite document, and storing the enterprise suite document;
performing the second portion of the task requires using the first result;
instructing the second AI assistant to perform the second portion of the task comprises instructing the second AI assistant to perform the second portion of the task using the first result;
identifying, by the AI assistant coordinator, the set of AI assistants;
identifying, for each AI assistant in the set of AI assistants, whether instructing the AI assistant is performed using an API or user emulation;
instructing an AI assistant that requires user emulation comprises instructing the AI assistant with a user emulator;
identifying, for each AI assistant in the set of AI assistants that requires access credentials, a location of access credentials for the AI assistant;
instructing an AI assistant that requires access credentials comprises accessing the AI assistant using the access credentials for the AI assistant;
at least one of the first AI assistant and the second AI assistant requires access credentials;
instructing at least one of the first AI assistant and the second AI assistant requires user emulation;
identifying, by the AI assistant coordinator, a set of data sources;
identifying, for each data source in the set of data sources that requires access credentials, a location of access credentials for the data source;
accessing a data source that requires access credentials comprises accessing the data source using the access credentials for the data source;
selecting a first data source in the set of data sources to perform at least the first portion of the task or to perform at least the second portion of the task;
instructing the first AI assistant comprises instructing the first AI assistant to use the first data source;
instructing the second AI assistant comprises instructing the second AI assistant to use the first data source;
annotating the aggregated result to include a citation to the first data source;
at least one AI assistant in the set of AI assistants comprises a copilot application;
the user provides access credentials for each AI assistant in the set of AI assistants that requires access credentials and for each data source in the set of data sources that requires access credentials;
a user creates the user input;
the user input comprises a prompt or a question comprising the task;
when performing the second portion of the task requires using the first result, the aggregated result includes the first result within the second result;
performing the second portion of the task is independent of performing the first portion of the task;
when performing the second portion of the task is independent of performing the first portion of the task, the aggregated result includes the first result alongside the second result;
at least one of the first AI assistant and the second AI assistant comprises generative AI; and
the enterprise suite document comprises a word processing document, a spreadsheet, or a presentation slide deck.

While the aspects of the disclosure have been described in terms of various examples with their associated operations, a person skilled in the art would appreciate that a combination of operations from any number of different examples is also within scope of the aspects of the disclosure.

### Example Operating Environment

FIG. 9 is a block diagram of an example computing device 900 (e.g., a computer storage device) for implementing aspects disclosed herein, and is designated generally as computing device 900. In some examples, one or more computing devices 900 are provided for an on-premises computing solution. In some examples, one or more computing devices 900 are provided as a cloud computing solution. In some examples, a combination of on-premises and cloud computing solutions are used. Computing device 900 is but one example of a suitable computing environment and is not intended to suggest any limitation as to the scope of use or functionality of the examples disclosed herein, whether used singly or as part of a larger set.

Neither should computing device 900 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 900 includes a bus 910 that directly or indirectly couples the following devices: computer storage memory 912, one or more processors 914, one or more presentation components 916, input/output (I/O) ports 918, I/O components 920, a power supply 922, and a network component 924. While computing device 900 is depicted as a seemingly single device, multiple computing devices 900 may work together and share the depicted device resources. For example, memory 912 may be distributed across multiple devices, and processor(s) 914 may be housed with different devices.

Bus 910 represents what may be one or more buses (such as an address bus, data bus, or a combination thereof). Although the various blocks of FIG. 9 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 9 and the references herein to a “computing device.” Memory 912 may take the form of the computer storage media referenced below and operatively provide storage of computer-readable instructions, data structures, program modules and other data for the computing device 900. In some examples, memory 912 stores one or more of an operating system, a universal application platform, or other program modules and program data. Memory 912 is thus able to store and access data 912a and instructions 912b that are executable by processor 914 and configured to carry out the various operations disclosed herein. Thus, computing device 900 comprises a computer storage device having computer-executable instructions 912b stored thereon.

In some examples, memory 912 includes computer storage media. Memory 912 may include any quantity of memory associated with or accessible by the computing device 900. Memory 912 may be internal to the computing device 900 (as shown in FIG. 9), external to the computing device 900 (not shown), or both (not shown). Additionally, or alternatively, the memory 912 may be distributed across multiple computing devices 900, for example, in a virtualized environment in which instruction processing is carried out on multiple computing devices 900. For the purposes of this disclosure, “computer storage media,” “computer storage memory,” “memory,” and “memory devices” are synonymous terms for the memory 912, and none of these terms include carrier waves or propagating signaling.

Processor(s) 914 may include any quantity of processing units that read data from various entities, such as memory 912 or I/O components 920. Specifically, processor(s) 914 are programmed to execute computer-executable instructions for implementing aspects of the disclosure. The instructions may be performed by the processor, by multiple processors within the computing device 900, or by a processor external to the client computing device 900. In some examples, the processor(s) 914 are programmed to execute instructions such as those illustrated in the flow charts discussed below and depicted in the accompanying drawings. Moreover, in some examples, the processor(s) 914 represents an implementation of analog techniques to perform the operations described herein. For example, the operations may be performed by an analog client computing device 900 and/or a digital client computing device 900. Presentation component(s) 916 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 900, across a wired connection, or in other ways. I/O ports 918 allow computing device 900 to be logically coupled to other devices including I/O components 920, some of which may be built in. Example I/O components 920 include, for example but without limitation, a microphone, joystick, game pad, satellite dish, scanner, printer, wireless device, etc.

Computing device 900 may operate in a networked environment via the network component 924 using logical connections to one or more remote computers. In some examples, the network component 924 includes a network interface card and/or computer-executable instructions (e.g., a driver) for operating the network interface card. Communication between the computing device 900 and other devices may occur using any protocol or mechanism over any wired or wireless connection. In some examples, network component 924 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 924 communicates over wireless communication link 926 and/or a wired communication link 926a to a remote resource 928 (e.g., a cloud resource) across a computer network 930. Various different examples of communication links 926 and 926a include a wireless connection, a wired connection, and/or a dedicated link, and in some examples, at least a portion is routed through the internet.

Although described in connection with an example computing device 900, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a computer-readable medium storing instructions that are operative upon execution by the processor to:
receive, by an artificial intelligence (AI) assistant coordinator, a user input comprising a task;
select a first AI assistant, in a set of AI assistants, to perform at least a first portion of the task;
select a second AI assistant in the set of AI assistants to perform at least a second portion of the task;
instruct the first AI assistant to perform the first portion of the task;
receive a first result from the first AI assistant;
instruct the second AI assistant to perform the second portion of the task;
receive a second result from the second AI assistant;
compile the first result and the second result into an aggregated result; and
perform an action using the aggregated result, based on at least the task.

2. The system of claim 1, wherein the action comprises an action selected from the list consisting of:
transmitting an email containing the aggregated result, appending the aggregated result into an enterprise suite document, and storing the enterprise suite document.

3. The system of claim 1, wherein instructing the second AI assistant to perform the second portion of the task comprises instructing the second AI assistant to perform the second portion of the task using the first result.

4. The system of claim 1, wherein the instructions are further operative to:
identify, by the AI assistant coordinator, the set of AI assistants;
identify, for each AI assistant in the set of AI assistants, whether instructing the AI assistant is performed using an API or user emulation, wherein instructing an AI assistant that requires user emulation comprises instructing the AI assistant with a user emulator; and
identify, for each AI assistant in the set of AI assistants that requires access credentials, a location of access credentials for the AI assistant, wherein instructing an AI assistant that requires access credentials comprises accessing the AI assistant using the access credentials for the AI assistant.

5. The system of claim 1, wherein at least one of the first AI assistant and the second AI assistant requires access credentials, and wherein instructing at least one of the first AI assistant and the second AI assistant requires user emulation.

6. The system of claim 1, wherein the instructions are further operative to:
identify, by the AI assistant coordinator, a set of data sources;
identify, for each data source in the set of data sources that requires access credentials, a location of access credentials for the data source, wherein accessing a data source that requires access credentials comprises accessing the data source using the access credentials for the data source;
select a first data source in the set of data sources to perform at least the first portion of the task or to perform at least the second portion of the task, wherein instructing the first AI assistant comprises instructing the first AI assistant to use the first data source or instructing the second AI assistant comprises instructing the second AI assistant to use the first data source; and
annotate the aggregated result to include a citation to the first data source.

7. The system of claim 1, wherein at least one AI assistant in the set of AI assistants comprises a copilot application.

8. A computer-implemented method comprising:
receiving, by an artificial intelligence (AI) assistant coordinator, a user input comprising a task;
selecting a first AI assistant, in a set of AI assistants, to perform at least a first portion of the task;
selecting a second AI assistant in the set of AI assistants to perform at least a second portion of the task;
instructing the first AI assistant to perform the first portion of the task;
receiving a first result from the first AI assistant;
instructing the second AI assistant to perform the second portion of the task;
receiving a second result from the second AI assistant;
compiling the first result and the second result into an aggregated result; and
performing an action using the aggregated result, based on at least the task.

9. The method of claim 8, wherein the action comprises an action selected from the list consisting of:
transmitting an email containing the aggregated result, appending the aggregated result into an enterprise suite document, and storing the enterprise suite document.

10. The method of claim 8, wherein performing the second portion of the task requires using the first result, and wherein instructing the second AI assistant to perform the second portion of the task comprises instructing the second AI assistant to perform the second portion of the task using the first result.

11. The method of claim 8, further comprising:
identifying, by the AI assistant coordinator, the set of AI assistants;
identifying, for each AI assistant in the set of AI assistants, whether instructing the AI assistant is performed using an API or user emulation, wherein instructing an AI assistant that requires user emulation comprises instructing the AI assistant with a user emulator; and
identifying, for each AI assistant in the set of AI assistants that requires access credentials, a location of access credentials for the AI assistant, wherein instructing an AI assistant that requires access credentials comprises accessing the AI assistant using the access credentials for the AI assistant.

12. The method of claim 8, wherein at least one of the first AI assistant and the second AI assistant requires access credentials, and wherein instructing at least one of the first AI assistant and the second AI assistant requires user emulation.

13. The method of claim 8, further comprising:
identifying, by the AI assistant coordinator, a set of data sources;
identifying, for each data source in the set of data sources that requires access credentials, a location of access credentials for the data source, wherein accessing a data source that requires access credentials comprises accessing the data source using the access credentials for the data source;
selecting a first data source in the set of data sources to perform at least the first portion of the task or to perform at least the second portion of the task, wherein instructing the first AI assistant comprises instructing the first AI assistant to use the first data source or instructing the second AI assistant comprises instructing the second AI assistant to use the first data source; and
annotating the aggregated result to include a citation to the first data source.

14. The method of claim 8, wherein at least one AI assistant in the set of AI assistants comprises a copilot application.

15. A computer storage device having computer-executable instructions stored thereon, which, on execution by a computer, cause the computer to perform operations comprising:
receiving, by an artificial intelligence (AI) assistant coordinator, a user input comprising a task;
selecting a first AI assistant, in a set of AI assistants, to perform at least a first portion of the task;
selecting a second AI assistant in the set of AI assistants to perform at least a second portion of the task;
instructing the first AI assistant to perform the first portion of the task;
receiving a first result from the first AI assistant;
instructing the second AI assistant to perform the second portion of the task;
receiving a second result from the second AI assistant;
compiling the first result and the second result into an aggregated result; and
performing an action using the aggregated result, based on at least the task.

16. The computer storage device of claim 15, wherein the action comprises an action selected from the list consisting of:
transmitting an email containing the aggregated result, appending the aggregated result into an enterprise suite document, and storing the enterprise suite document.

17. The computer storage device of claim 15, wherein performing the second portion of the task requires using the first result, and wherein instructing the second AI assistant to perform the second portion of the task comprises instructing the second AI assistant to perform the second portion of the task using the first result.

18. The computer storage device of claim 15, wherein the operations further comprise:
identifying, by the AI assistant coordinator, the set of AI assistants;
identifying, for each AI assistant in the set of AI assistants, whether instructing the AI assistant is performed using an API or user emulation, wherein instructing an AI assistant that requires user emulation comprises instructing the AI assistant with a user emulator; and
identifying, for each AI assistant in the set of AI assistants that requires access credentials, a location of access credentials for the AI assistant, wherein instructing an AI assistant that requires access credentials comprises accessing the AI assistant using the access credentials for the AI assistant.

19. The computer storage device of claim 15, wherein at least one of the first AI assistant and the second AI assistant requires access credentials, and wherein instructing at least one of the first AI assistant and the second AI assistant requires user emulation.

20. The computer storage device of claim 15, wherein the operations further comprise:
identifying, by the AI assistant coordinator, a set of data sources;
identifying, for each data source in the set of data sources that requires access credentials, a location of access credentials for the data source, wherein accessing a data source that requires access credentials comprises accessing the data source using the access credentials for the data source;
selecting a first data source in the set of data sources to perform at least the first portion of the task or to perform at least the second portion of the task, wherein instructing the first AI assistant comprises instructing the first AI assistant to use the first data source or instructing the second AI assistant comprises instructing the second AI assistant to use the first data source; and
annotating the aggregated result to include a citation to the first data source.
